(19) United States
(12) Patent Application Publication
(10) Pub. No.: US 2005/0140790 A1
(43) Pub. Date: Jun. 30, 2005

(54) Mobile communication terminal equipped with TV reception function

(75) Inventors: Dong-Uk Min, Seocho-Gu (KR); Kun-Pil Jung, Seocho-Gu (KR); Byoung-Hwan Choi, Seocho-Gu (KR); Bo-Hong Seo, Seocho-Gu (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: CURITEL COMMUNICATIONS, INC., Seocho-Gu (KR)

(21) Appl. No.: 11/017,799

(22) Filed: Dec. 22, 2004

(30) Foreign Application Priority Data
Dec. 29, 2003 (KR) 10-2003-0098910
Dec. 29, 2003 (KR) 10-2003-0098906
Dec. 29, 2003 (KR) 10-2003-0098883

(51) Int. Cl. H04N 5/225

(52) U.S. Cl. 348/207.99

(57) ABSTRACT

Disclosed is a mobile communication terminal capable of taking a picture and allowing a user to view TV. The mobile communication terminal includes: a display unit; a camera unit for converting an optical signal inputted through a lens system into an electrical signal and outputting the electrical signal; a TV reception unit for extracting an image signal from a TV signal received over the air; and a signal processing unit for alternatively processing a first image signal outputted from the camera unit or a second image signal outputted from the TV reception unit, and outputting the processed image signal to the display unit.

### BACKGROUND OF THE INVENTION

This application claims the priorities of Korean Patent Application Nos. 2003-98883, 2003-98906, and 2003-98910, filed on Dec. 29, 2003, in the Korean Intellectual Property Office, the entire contents of which are hereby incorporated by reference.

1. Field of the Invention

The present invention relates to a mobile communication terminal and, more particularly, to a mobile communication terminal enabling viewing of TV.

2. Description of Related Art

As use of mobile communication terminals continues to spread, the technology of this field is being developed. Further, various functions continue to be added due to user demand and competition among terminal manufacturers.

Mobile terminals having cameras have rapidly gained in popularity of late, such that they now comprise the majority of the mobile terminal market. Recently, mobile communication terminals equipped with TV function have been put on the market. Such trends, together with the development of large-scale memory, are accelerating the conversion of the mobile terminal into a personal multimedia device.

However, in order to embody a large variety of functions in the terminal, whose hand held function is emphasized, an efficient architecture is needed to suitably control systems as well as to solve the physical problem of securing sufficient space in the terminal. Furthermore, a problem of inefficiency has been present to date in that each time a new function is added, a new mobile terminal must be designed.

### SUMMARY OF THE INVENTION

The present invention provides a system architecture that efficiently operates in a mobile communication terminal equipped with a camera and a TV viewing function.

The present invention also provides a mobile communication terminal enabling viewing of TV, which is capable of transmitting a received television image to an external device and minimizing wireless interference between TV-viewing related components and other components.

In accordance with an aspect the present invention, there is provided a mobile communication terminal comprising: a display unit; a camera unit for converting an optical signal inputted through a lens system into an electrical signal and outputting the electrical signal; a TV reception unit for extracting an image signal from a TV signal received over the air; and a signal processing unit for alternatively processing a first image signal outputted from the camera unit or a second image signal outputted from the TV reception unit, and outputting the processed image signal to the display unit.

In accordance with another aspect of the present invention, there is provided a mobile communication terminal comprising: a display unit; a TV reception unit which is detachably coupled to a main body of the mobile communication terminal and extracts an image signal from a TV signal received over the air; and a signal processing unit for processing an image signal outputted from the TV reception unit and outputting the processed image signal to the display unit.

The signal processing unit may control operations of the camera unit and the TV reception unit using a serial bus.

The serial bus may be an I²C bus.

The signal processing unit may comprises: a media interface for alternatively receiving the first image signal or the second image signal; an image processor for compressing or processing the image signal received from the media interface; an image output port for converting the image signal processed in the image processor into display data and outputting the display data; a bus interface for controlling operations of the camera unit and the TV reception unit; and a controller for controlling the overall operation of the signal processing unit and an external module.

The mobile communication terminal may further comprise a flash memory for storing data processed in the signal processing unit, wherein the signal processing unit may further comprise a memory controller for controlling the flash memory.

The flash memory may be a detachable card-type memory.

The controller in the signal processing unit may control the bus interface to access a tuner and a decoder in the TV reception unit individually by assigning an address to each of the tuner and the decoder.

The TV reception unit may be detachably coupled to a main body of the mobile communication terminal.

The TV reception unit may comprise: a tuner for demodulating a wireless broadcast signal received through an antenna; a decoder for decoding the demodulated broadcast signal into digital data; a bus interface for receiving a serial bus control signal from the signal processing unit; and a TV controller for performing a control operation according to a control signal received from the bus interface.

The TV reception unit may further comprise an audio processor for processing an audio signal outputted from the tuner, and an audio output unit for outputting the audio signal processed in the audio processor.

The signal processing unit may further comprise an external device interface for converting the image signal outputted from the TV reception unit into digital image data format and outputting the digital image data format to an external interface port.

### BRIEF DESCRIPTION OF THE DRAWINGS

The above and other objects, features and other advantages of the present invention will be more clearly understood from the following detailed description taken in conjunction with the accompanying drawings, in which:

FIG. 1A is a view showing a mobile communication terminal in accordance with an embodiment of the present invention;

FIG. 1B is a view showing a mobile communication terminal in accordance with another embodiment of the present invention;

FIG. 2 is a view showing an example in which a mobile communication terminal in accordance with the present invention is connected to an external device;

FIG. 3 is a block diagram showing a construction of a mobile communication terminal in accordance with an embodiment of the present invention;

FIG. 4 is a block diagram showing a more detailed construction of the mobile communication terminal shown in FIG. 3;

FIG. 5 is a block diagram showing a construction of a mobile communication terminal in accordance with another embodiment of the present invention;

FIG. 6 is a block diagram showing a more detailed construction of the mobile communication terminal shown in FIG. 5; and

FIG. 7 is a view showing an embodiment of a tuner that can be equipped into the mobile communication terminal shown in FIGS. 4 and 6.

### DETAILED DESCRIPTION OF THE INVENTION

Exemplary embodiments of the present invention will now be described below in more detail with reference to the accompanying drawings. Like numerals refer to like elements throughout the specification.

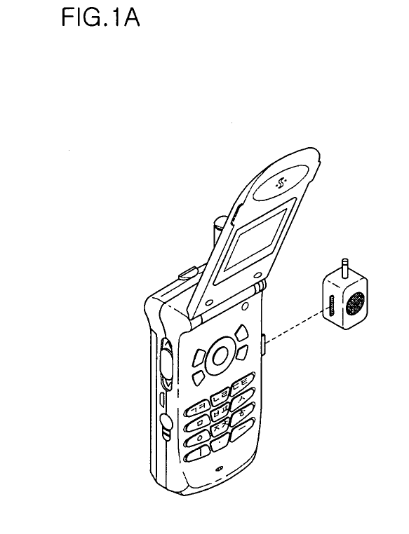

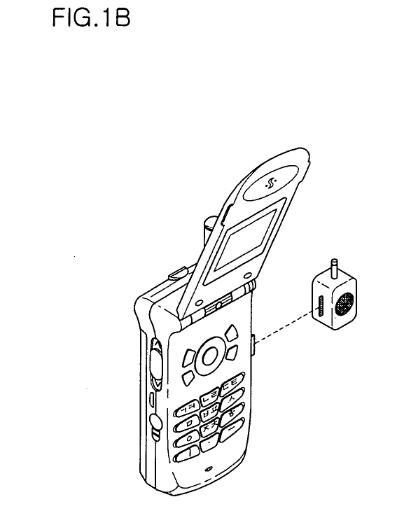

FIG. 1A is a view showing the external appearance of a mobile communication terminal in accordance with an embodiment of the present invention. The mobile communication terminal in accordance with the present embodiment consists of a main body and a TV reception module, which is detachably manufactured. The TV reception module and the main body are connected to each other through a connector. The TV reception module includes a slot used for circuit connections, where a printed circuit board can be inserted, and a TV reception antenna. The main body of the mobile communication terminal has a female connector coupled to the slot to provide an electrical connection therebetween.

FIG. 1B is a view showing the external appearance of a mobile communication terminal in accordance with another embodiment of the present invention. The mobile communication terminal in accordance with the present embodiment further includes a camera unit provided in the main body thereof, differently with the embodiment shown in FIG. 1A.

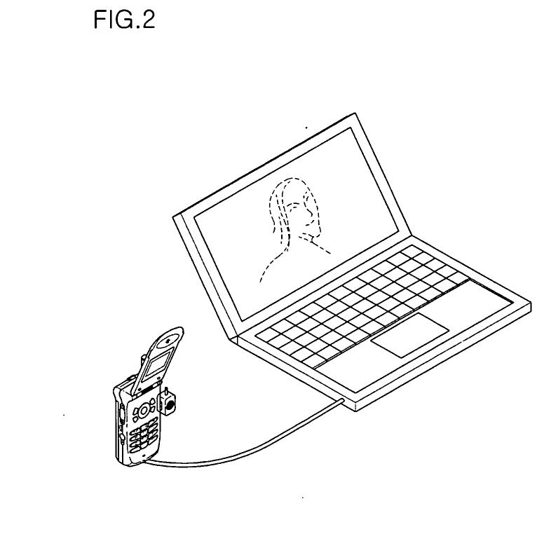

FIG. 2 is a view showing an example in which a mobile communication terminal in accordance with the present invention is connected to an external device. For example, a USB port included in the terminal and a USB port included in a notebook computer are connected to each other using a cable. The notebook computer is equipped with applications for controlling communication with the mobile communication terminal and processing various functions. A USB host of the notebook computer detects a USB slave of the terminal based on a plug-and-play scheme. At this time, the terminal also executes the applications to transmit a TV signal to an external device by a user's setting or under the control of the computer.

Accordingly, television signals received in a TV reception module of the terminal are transmitted in a stream format to the computer through the cable and displayed on a larger screen through a player executed on a computer display. However, the external device in accordance with the present invention is not limited to the computer, but may be applied to various display devices which support interfaces such as USB. Furthermore, the method of transmitting the image data is not limited to the above-mentioned streaming method, but may include a method in which the broadcast signals are stored in an internal memory of the terminal and then downloaded into the external device using a block transmission scheme.

Although applications executed in the personal computer basically include a player function for playing TV signals transmitted in the stream format, they may further include various graphic filters for compressing and storing received images in a hard disk of the computer, or capturing selected frames or filtering reproduced or captured images. Since elementary technologies needed in the application programs, such as image reproduction, image decoding and image capture technologies, are known in corresponding fields, detailed descriptions thereof are omitted for brevity.

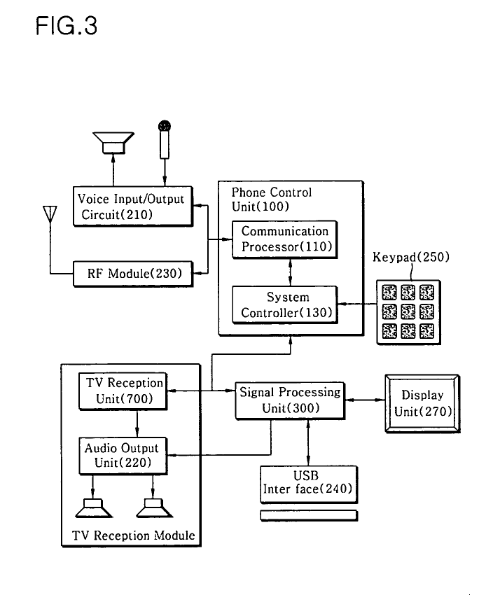

FIG. 3 is a block diagram showing a construction of a mobile communication terminal in accordance with an embodiment of the present invention. The mobile communication terminal in accordance with the present embodiment typically includes a phone control unit 100 and its accessory circuits, which are common components in typical mobile communication terminals, a TV reception unit 700, and a signal processing unit 300.

In accordance with a preferred embodiment of the present invention, a TV reception module, which comprises the TV reception unit 700 and an audio output unit 220, is constructed of a separate module which is detachably coupled to the main body.

Examples of the accessory circuits include a keypad 250, a display unit 270 for displaying a menu and an operation state, a radio frequency (RF) module 230 for extracting voice and data signals from wireless signals transmitted/received through the antenna, and a voice input/output circuit 210 for inputting and outputting the voice signal received from the RF module through a microphone and a speaker.

The keypad 250 and display unit 270, which is normally a liquid crystal display, can be constructed by methods well known in the art. The RF module 230, which includes an antenna and RF circuit, is used to communicate with a base station. In this specification, the RF module is explicated to be available in mobile communication schemes which will appear in the future, as well as the existing mobile communication schemes such as CDMA, TDMA, PDC, and GSM. The voice input/output circuit 210 is a known construction that converts digital voice data into an analog voice signal or vice versa and includes an accessory circuit such as audio amplifier or filter.

The phone control unit 100 includes a communication processor 110 for controlling the voice and data communication, and a system controller 130 for controlling the overall system according to an operation signal inputted from the keypad 250 or an operation state. Baseband processing circuits in RF module 230 and the phone control unit 100 are integrated into a commercially available single chip, such as Qualcomm's MSM series chip, in the case of the CDMA scheme. Such an integrated circuit (IC) chip includes dedicated hardware for processing communication services, a digital signal processor, and core firmware for processing image compression, blue tooth communication, global positioning system (GPS) and the like, which are basically provided for the signal processor. Furthermore, the IC chip has a built-in microprocessor for controlling the system. The system controller 130 is supported by a convenient application environment such as a virtual machine, and can process all sorts of controls in accordance with characteristic aspects of the present invention using programs.

A mobile communication terminal in accordance with an embodiment of the present invention includes a TV reception unit 700 for extracting an image signal from a TV signal received over the air and outputting the image, and a signal processing unit 300 for processing the image signal outputted from the TV reception unit 700 and outputting the image signal to the display unit 270, or for converting the image signal into digital image data format and outputting the digital image data format to an external interface port 240.

In accordance with the present embodiment, the TV reception unit 700 and signal processing unit 300 are each provided as a single package. The TV reception unit 700 is constructed of a package including several IC modules. Although the signal processing unit 300 is a single IC package, it includes a digital signal processing unit, internal memories, interface modules, and a microprocessor therein.

In accordance with the present embodiment, the external interface port 240 is a USB port. According to USB specification, it is possible to support streaming transmission and to transmit compressed video in real time. The interface port can be incorporated in a signal jack formed in the lower part of the phone, or can be provided as a separate connector.

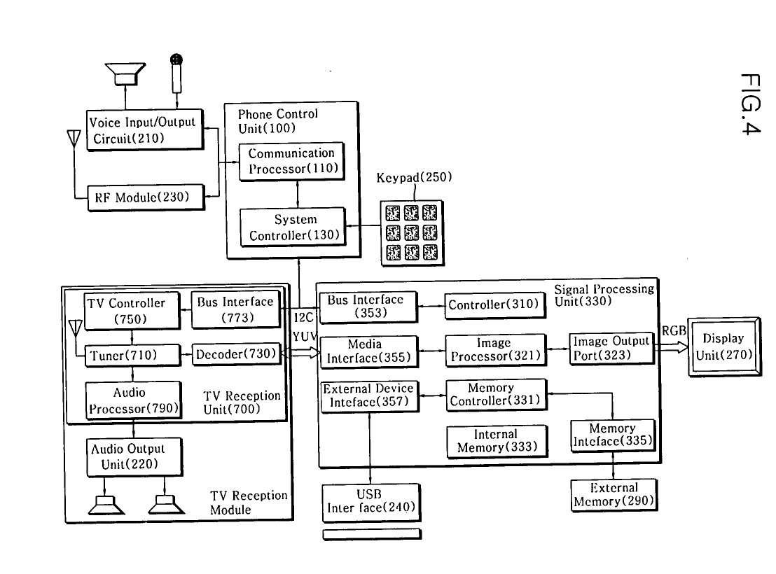

FIG. 4 is a block diagram showing a more detailed construction of the mobile communication terminal shown in FIG. 3.

The signal processing unit 300 includes a media interface 353 for receiving an image signal from the TV reception unit 700, an image processor 321 for processing the image signal inputted from the media interface 353, an image output port 323 for converting the image signal processed in the image processor 321 into display data and outputting the display data to the display unit 270, and an external device interface 357 for converting the image signal processed in the image processor 321 into digital image data format and outputting the digital image data format to the interface port 240.

The signal processing unit 300, developed by the present applicant for signal processing in a camera phone, can be applied to the TV reception unit 700 without alteration. In addition, the existing signal processing unit 300 used for the camera unit 500 can be commonly used without adding a separate signal processing module used for the TV reception unit 700, which is a characteristic merit of the present invention.

The media interface 355 receives 8-bit image data in YUV format and buffers the data into its internal memory. The image processor 321 includes a codec for converting interlaced TV signals into progressive signals, scaling through interpolation and/or decimation to suit the resolution of the display unit, and storing the image data in the internal memory or decompressing the image data. In accordance with an embodiment of the present invention, the codec includes a Motion Picture Experts Group (MPEG) encoder/decoder and a Joint Photographic Experts Group (JPEG) encoder/decoder which compresses a captured image frame to a still image, stores and reads out the still image. The above-mentioned encoder/decoder is embodied by a DSP and a core. Additionally, the image processor 321 may include a resolution enhancement circuit for improving image quality, and functions for controlling contrast and brightness. Furthermore, the image processor 321 may include several simple filter functions for creating graphic effects.

In accordance with another embodiment of the present invention, the image output port 323 outputs the image data, which is outputted from the media interface 355 directly or from the image processor 321, to the display unit 270 as 16-bit RGB data. In accordance with the present embodiment, the image signal received from the TV reception unit 700 can be compressed in the image processor 321 using the MPEG scheme, and stored in a flash memory 290 through a memory controller 331 and a memory interface 333. The image received from the TV reception unit 700 can be frame captured and compressed into JPEG format in the image processor 321, and stored in the flash memory 290 as a still image through the memory controller 331 and memory interface 333. The motion picture or still image stored in the flash memory 290 can be decompressed in the image processor 321 and displayed in the display unit 270 through the image output port 323.

In accordance with another embodiment of the present invention, the terminal may further include a large-scale memory capable of recoding an image, and the signal processing unit 300 may further include a memory controller 331 for controlling a procedure in which the image data processed in the image processor 321 is recorded in and read out from the large-scale memory. At this time, the memory controller 331 can control the internal memory 333, and the external memory 290 such as a large-scale flash memory. The external memory 290 may be a detachable card type flash memory such as a single in-line memory module (SIMM). However, the external memory 290 in the present invention is not limited to the flash memory, but may be a hard disk or any other equivalent memory device in the case of a personal digital assistant (PDA).

A mobile communication terminal in accordance with another embodiment of the present invention includes a memory for storing data processed in the signal processing unit, e.g., the internal memory 333, and the signal processing unit 300 includes the memory controller 331 for the memory. The internal memory 333 can be constructed of a large-scale flash memory, a RAM for buffering the internal data, and the like.

In accordance with the present embodiment, the external device interface 357 is a USB slave controller. The external device interface 357 outputs compressed image data, which is stored in the internal memory 333, in USB streaming format through the USB interface port 240. However, the present invention is not limited to the USB interface port 240 illustrated in this embodiment, but may include an Infra-Red (IR) interface, a Bluetooth interface, and the like.

In more detail, the image data in YUV format received from the TV reception unit 700 is buffered into the media interface 355 and is then provided to the image processor 321. The image processor 321 processes the data using preset brightness and contrast values, and then compresses the data in MPEG format using its internal codec. The compressed image data passes through the memory controller 331 and is buffered into the internal memory 333. The external device interface 357 reads out the compressed image data from the internal memory 333, converts the data into USB streaming packets, and outputs the packets to the USB interface port 240.

Alternatively, the image data may be directly inputted from the media interface 355 to the external device interface 357 in the case that the external device interface 357 is capable of processing data at high speed. In the specification, the image processor 321 is explicated to cover a construction having the minimal function to distribute the image data inputted from the media interface 355 to the external device interface 357 and the image output port 323.

In accordance with another preferred embodiment of the present invention, the signal processing unit 300 controls operation of the TV reception unit 700 via a serial bus. An I²C bus is an example of the serial bus. The I²C bus, also called an “Inter-IC bus”, is a serial bus developed by Philips Electronics and a two-wire, bidirectional serial bus that provides a serial data line and a serial clock line interface to exchange information between devices.

In accordance with the present invention, the image signal in the terminal is circulated on a bus in a single format, which is YUV format in this embodiment. Accordingly, each of the image processing modules converts the image signal into the YUV format and outputs the converted signal. An interface between the terminal and external devices will be described in detail below.

In accordance with another embodiment of the present invention, the TV reception unit 700 includes a tuner 710 for demodulating a wireless broadcast signal received from the antenna, a decoder 730 for decoding the demodulated broadcast signal and outputting the signal as digital data, and a TV controller 750 for controlling operations in accordance with a control instruction signal generated from an external device. The TV reception unit 700 includes an antenna for receiving radio signals. The antenna may be provided separately from an antenna for mobile communications. Alternatively, a micro-strip patch antenna may be shared for both TV reception and mobile communications.

In accordance with another preferred embodiment of the present invention, the mobile communication terminal further includes an audio output unit 220 for outputting an audio signal outputted from the TV reception unit 700 in the form of audible sound. The TV reception unit 700 further includes an audio processor 790 for processing audio data outputted from a tuner 710 and outputting the data to the audio output unit 220. At this time, the audio signal component of the television signal demodulated in the tuner 710 is provided to the audio output unit 220 in an analog form. When considering delay incurred when the image data is processed in the signal processing unit 300, transmitted to the external device, and reproduced in the external device, the audio output unit 220 may include a delay circuit for delaying the outputted audio signal.

The tuner 710 may be one of existing analog broadcast tuners, such as an NTSC or PAL tuner, or may be a dual-mode tuner that supports both schemes. In accordance with another embodiment, the tuner 710 may support a multimedia broadcast for the mobile communication such as a digital multimedia broadcasting (DMB) based on a satellite or a multimedia broadcast based on a wireless LAN.

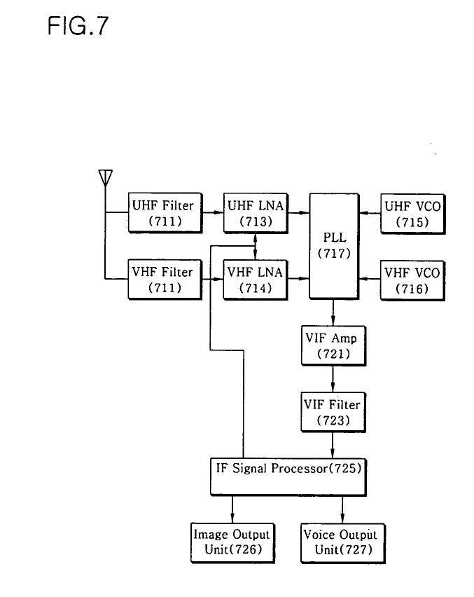

FIG. 7 is a view showing an embodiment of the tuner 710. The wireless broadcast signal received from the antenna is divided into a UHF band signal and a VHF band signal while it passes through a UHF filter 711 and a VHF filter 712. The signal of each band is filtered and amplified while it passes through each of low noise amplifiers (LNAs) 713 and 714. The amplified signal is provided to a phase-locked loop (PLL) circuit 717 so that signals of each channel are selected according to channel tuning instructions and then mixed with a local oscillator signal to be demodulated to an intermediate frequency (IF) signal. At this time, a local oscillation frequency for each signal is provided from each of voltage-controlled oscillators 715 and 716. The oscillation frequencies of these oscillators are controlled by the TV controller 750 for controlling channel tuning, which is shown in FIG. 3. The demodulated IF signal is demodulated once again by an IF signal processor 725 into analog image and audio signals, which are in turn outputted to image and voice output units 726 and 727, respectively. At this time, the IF signal processor 725 is controlled by the TV controller 750 for controlling the channel tuning, which is shown in FIG. 3. Also, an output level (i.e., volume) of the voice output unit 727 is also controlled by the TV controller 750.

In accordance with another embodiment of the present invention, the decoder 730 transforms an analog image signal outputted from the image output portion 726 into a digital YUV signal. The operation of the decoder 730 is controlled by the TV controller 750.

A description will now be given of how the signal processing unit 300, which serves as a host in media signal processing, controls the TV reception unit 700 with reference to FIG. 4.

In accordance with another embodiment of the present invention, the TV reception unit 700 includes a bus interface 733 for receiving a serial bus control signal from the signal processing unit 300, and a TV controller 750 for controlling operations according to a control signal received from the bus interface 773.

In accordance with another embodiment of the present invention, the signal processing unit 300 includes a media interface 355 for receiving image signals from the TV reception unit 700, a bus interface 353 for controlling operation of the TV reception unit 700, and a controller 310 for controlling external modules through the bus interface 353. The signal processing unit 300 selectively activates the TV reception unit 700 using a known chip select logic.

At this time, in accordance with another preferred embodiment of the present invention, the controller 310 of the signal processing unit 300 controls the bus interface 353 to access the tuner 710 and the decoder 730 of the TV reception unit 700 individually by assigning an address to each of the tuner 710 and the decoder 730.

Once a module is selected by the chip select logic, the controller 310 of the signal processing unit 300 sets operational environments of the module using the bus interface 353, or controls operation of the module through the bus interface 353. In accordance with an embodiment of the present invention, the bus interfaces 353, 573 and 773 use an I²C bus for communications. Addresses can be individually assigned to a channel tuning operation, an audio output level adjusting operation, and a decoding operation in the TV reception unit 700. The controller 310 can control the operation of changing TV channels, adjusting volume, or changing the format of outputted images, by writing control instructions into these addresses through the bus interface 353.

The signal processing unit 300 has a very flexible design system due to the inclusion of the chip select logic and the bus interface 353. For example, by mounting a camera module, which is designed to output image data in YUV format that is supported by the media interface 355, onto a mobile communication terminal, the mobile communication terminal can be equipped with both TV-viewing and image-capture functionality.

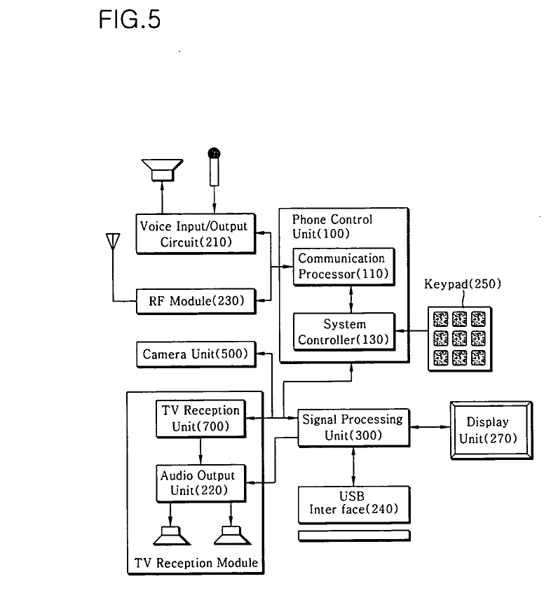

FIG. 5 is a block diagram showing a construction of a mobile communication terminal in accordance with another embodiment of the present invention. As in the embodiment shown in FIG. 3, the mobile communication terminal includes a phone control unit 100 and its accessory circuits, which are common in typical mobile communication terminals, a TV reception unit 700, and a signal processing unit 300. In addition, the mobile communication terminal further includes a camera unit 500.

In accordance with another preferred embodiment of the present invention, a TV reception module comprising the TV reception unit 700 and an audio output unit 220 is constructed of a separate module that is detachably coupled with the main body.

The accessory circuits include a keypad 250, a display unit 270 for displaying a menu and an operation state, a RF module 230 for extracting voice and data signals from wireless signals transmitted/received through an antenna, and a voice input/output circuit 210 for inputting and outputting the voice communication signal received from the RF module through a microphone and a speaker.

The keypad 250 and display unit 270, which is typically a liquid crystal display, can be constructed by methods well known in the art. The RF module 230 includes an antenna and RF circuit that are used to communicate with a base station. The voice input/output circuit 210 is a known construction that converts digital voice data into an analog voice signal or vice versa and includes an accessory circuit such as an audio amplification circuit or a filter.

A baseband circuit of the RF module 230 and most circuits of the phone control unit 100 are integrated into a commercially available single chip. This IC chip, which is usually called a mobile station modem (MSM) chip, includes dedicated hardware for communication processing, a digital signal processor, and a general-purpose microprocessor. Logically, the IC chip includes a communication processor 110 for processing voice and data communications, and a system controller 130 for controlling the overall system according to an operation signal inputted from the keypad or an operation state.

In accordance with another preferred embodiment of the present invention, the mobile communication terminal includes a TV reception unit 700 for extracting an image signal from a TV signal received over the air and outputting the image, and a signal processing unit 300 for processing the image signal outputted form the TV reception unit 700 and outputting the image signal to the display unit 270, or for converting the image signal into digital image data format and outputting the digital image data format to an external interface port 240.

In accordance with the present embodiment, the TV reception unit 700 and signal processing unit 300 are each provided as a single package. The TV reception unit 700 is constructed of a package including several IC modules. Although the signal processing unit 300 is a single IC package, it includes a digital signal processing unit, internal memories, interface modules, and a microprocessor.

In accordance with the present embodiment, the external interface port 240 is a USB port. According to USB specification, it is possible to support streaming transmission and to transmit compressed video in real time. The interface port can be incorporated in a single jack formed in the lower part of the phone, or can be provided as a separate connector.

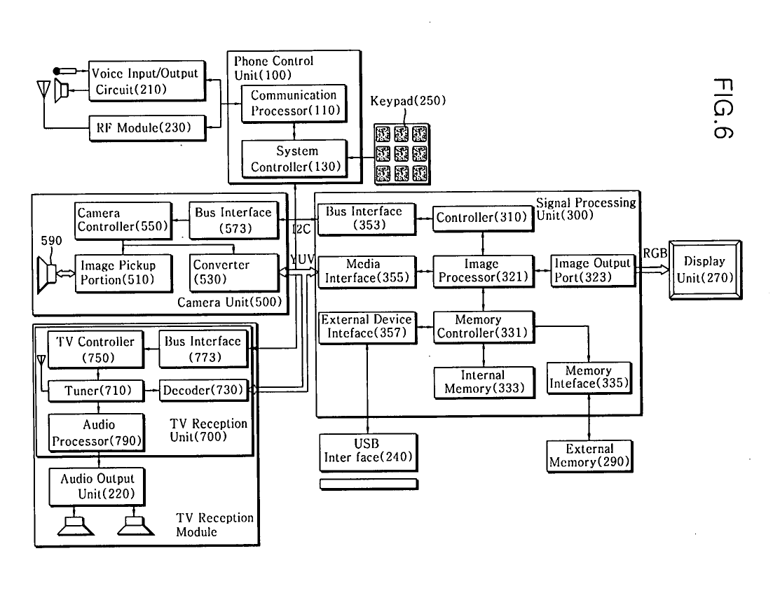

FIG. 6 is a block diagram showing a more detailed construction of the mobile communication terminal shown in FIG. 5. The camera unit 500 converts an optical signal inputted from a lens system into an electrical signal. The TV reception unit 700 extracts an image signal from a TV signal received over the air.

The signal processing unit 300, developed by the present applicant for signal processing in a camera phone, can be applied to the TV reception unit 700 without alteration. In addition, the existing signal processing unit 300 used for the camera unit 500 can be commonly used without adding a separate signal processing module used for the TV reception unit 700, which is a characteristic merit of the present invention. The signal processing unit 300 alternatively processes a first image signal outputted from the camera unit 500 or a second image signal outputted from the TV reception unit 700, and outputs the selected signal to the display unit 270.

In accordance with another preferred embodiment of the present invention, the signal processing unit 300 includes chip select logic used to alternatively select the camera unit 500 and the TV reception unit 700. The signal processing unit 300 controls operations of the camera unit 500 and the TV reception unit 700 via a serial bus, which is an I²C bus in an embodiment.

In accordance with another preferred embodiment of the present invention, the camera unit 500 includes a lens system 590, an image pickup portion 510 for converting an optical signal from the lens system 590 into an electrical signal, a converter 530 for processing and converting a signal outputted from the image pickup portion 510 to a digital signal which is in turn converted into a format suitable for input to the signal processing unit, and a camera controller 550 for controlling the overall operation of the camera unit 500.

The lens system 590, composed of one or more compact lenses, focuses and provides light to the image pickup portion 510. The image pickup portion 510, which is typically constructed of a complementary metal-oxide-semiconductor (CMOS) or a charge coupled device (CCD) image sensor, is a well-known component used for converting light into electrical signals in each pixel and sequentially outputting the converted electrical signals in synchronization with clocks. The converter 530 converts a current or voltage, which is proportional to the brightness of an image outputted from the image pickup portion 510, into digital data, which is in turn converted into a YUV format. The converter 530 may further include a codec for compressing captured images into JPEG or MPEG format.

In accordance with the present invention, the image signal in the terminal is circulated on a bus in a single format, which is YUV format in this embodiment. Accordingly, each of the image processing modules transforms the image signal into the YUV format. The camera controller 550 controls the operation of the camera unit 500 according to instructions from the external devices. In the camera unit 500, the camera controller 550 may be implemented with a microprocessor or a digital logic circuit. An interface construction with the external devices will be described in detail below.

In accordance with another embodiment of the present invention, the TV reception unit 700 includes a tuner 710 for demodulating a broadcast signal received via the antenna, a decoder 730 for decoding the demodulated broadcast signal into digital data, and a TV controller 750 for controlling the operation of the TV receiver unit 700 according to a control instruction signal from the external device. The TV reception unit 700 includes an antenna for receiving signals broadcast over the air. The antenna may be provided separately from an antenna for mobile communications. Alternatively, a micro-strip patch antenna may be shared for both TV reception and mobile communications.

The tuner 710 may be one of typical analog broadcast tuners which support National Television System Committee (NTSC) broadcast system and/or Phase Alternation by Line (PAL) broadcast system. In another embodiment, the tuner 710 may support multimedia broadcast for mobile communications, such as wireless local area network (LAN) based multimedia broadcast or satellite based digital multimedia broadcast (DMB). The tuner 410 may be the same as that of the embodiment shown in FIG. 4 and further detailed description thereof is thus omitted below.

In accordance with another preferred embodiment of the present invention, the decoder 730 generates a digital YUV signal from an analog image outputted from the image output unit 726. The TV controller 750 controls operation of the decoder 730.

In accordance with another preferred embodiment of the present invention, the signal processing unit 300 includes a media interface 353 for receiving an image signal form the TV reception unit 700, an image processor 321 for processing the image signal outputted from the media interface 353, an image output port 323 for converting the image signal processed in the image processor 321 into display data and outputting the display data to the display unit 270, and an external device interface 357 for converting the image signal processed in the image processor 321 into digital image data format and outputting the digital image data format to the interface port 240.

The media interface 355 receives 8-bit image data in YUV format and buffers the data into an internal memory. The image processor 321 includes a codec for converting interlaced TV signals into progressive TV signals, scaling through interpolation and/or decimation to suit the resolution of the display unit, and storing the image data in the internal memory 333 or decompressing the image data. In accordance with an embodiment of the present invention, the codec includes an MPEG encoder/decoder, and a JPEG encoder/decoder for compressing captured images, storing and reading out the compressed image. The above-mentioned encode/decoder is embodied by a DSP and a core. Additionally, the image processor 321 may include a resolution enhancement circuit for improving image quality, and functions for controlling contrast and brightness. Furthermore, the image processor 321 may include several simple filter functions for creating graphic effects.

In accordance with another preferred embodiment of the present invention, the image output port 323 outputs the image data, which is output from the media interface 355 directly or from the image processor 321, to the display unit 270 as 16-bit RGB data. In accordance with the present embodiment, the image signal received from the TV reception unit 700 can be compressed into MPEG format in the image processor 321, and stored in a flash memory 290 through a memory controller 331 and a memory interface 333. The image received from the TV reception unit 700 can be frame captured and compressed into JPEG format in the image processor 321, and stored in the flash memory 290 as a still image through the memory controller 331 and memory interface 333. The motion picture or still image stored in the flash memory 290 can be decompressed in the image processor 321 and displayed on the display unit 270 through the image output port 323.

In accordance with another embodiment of the present invention, the terminal may further include a large-scale memory capable of recoding an image, and the signal processing unit 300 may further include a memory controller 331 for controlling a procedure in which the image data processed in the image processor 321 is recorded in and read out from the large-scale memory. At this time, the memory controller 331 can control the internal memory 333, and the external memory 290 such as a large-scale flash memory. The external memory 290 may be a detachable card type flash memory such as a SIMM module. However, the external memory 290 is not limited to the flash memory, but may be a hard disk or any other equivalent memory device in the case of a PDA.

A mobile communication terminal in accordance with another preferred embodiment of the present invention includes a memory for storing data processed in the signal processing unit, e.g., the internal memory 333, and the signal processing unit 300 includes the memory controller 331 for the memory. The internal memory 333 can be constructed of a large-scale flash memory, a RAM for buffering the internal data, and the like.

In accordance with the present embodiment, the external device interface 357 is a USB slave controller. The external device interface 357 outputs compressed image data, which is stored in the internal memory 333, in USB streaming format through the USB interface port 240. However, the present invention is not limited to the USB interface port 240 illustrated in this embodiment, but may include an IR interface, a Bluetooth interface, and the like.

A description will now be given of how the signal processing unit 300, which operates as a host in media signal processing, controls the camera unit 500 and the TV reception unit 700 with reference to FIG. 6.

The camera unit 500 includes a bus interface 573 for receiving a control signal from the signal processing unit 300, and a camera controller 550 for controlling the overall operation of the camera unit according to a control signal received from the bus interface 573.

In accordance with another preferred embodiment of the present invention, the TV reception unit 700 includes a bus interface 773 for receiving a serial bus control signal from the signal processing unit 300, and a TV controller 750 for controlling the overall operation of the TV reception unit 700 according to a control signal received from the bus interface 773.

In accordance with another preferred embodiment of the present invention, the signal processing unit 300 includes a media interface 355 for alternatively receiving a first image signal from the camera unit 500 or a second image signal from the TV reception unit 700, a bus interface 353 for controlling operations of the camera unit 500 and the TV reception unit 700, a controller 310 for controlling external devices through the bus interface 353, and a chip select logic (not shown) for selecting the camera unit 500 and the TV reception unit 700.

At this time, the controller 310 of the signal processing unit 300 controls the bus interface 353 to access the tuner 710 and the decoder 730 of the TV reception unit 700 individually by assigning an address to each of the tuner 710 and the decoder 730.

Once one module is selected by the chip select logic, the controller 310 of the signal processing unit 300 sets operational environments of the module using the bus interface 353, or controls operation of the module through the bus interface 353. In accordance with an embodiment of the present invention, the bus interfaces 353, 573 and 773 use an I²C bus for communications. Addresses can be individually assigned to an imaging operation, a brightness adjusting operation, and a resolution setting operation in the camera unit 500. In addition, addresses can be individually assigned to a channel tuning operation, an audio output level adjusting operation, and a decoding operation in the TV reception unit 700. The controller 310 can control the operation of imaging, adjusting camera brightness, or setting the resolution of captured images, by writing control instructions into the addresses through the bus interface 353. Further, the controller 310 can control the operation of changing TV channels, adjusting volume, or changing the format of outputted images, by writing control instructions into these addresses through the bus interface 353.

Since image signals outputted from both the converter 530 of the camera unit 500 and the decoder 730 of the TV reception unit 700 through the above-mentioned control operations have 8-bit YUV format, the image signals can be inputted to the media interface 355 of the signal processing unit 300 and processed in the image processor 321 or image output port 323.

As described above, a mobile communication terminal in accordance with the present invention can process images of a camera unit and a TV reception unit with a single signal processing unit, thereby simplifying hardware configuration and reducing manufacturing costs.

The mobile communication terminal includes a bus for operation control, which allows modules to be systematically controlled, in addition to an image-processing path, thereby facilitating system design or modification.

In addition, the mobile communication terminal can transmit an image signal inputted to a TV reception module to an external device such as a personal computer, so that a user can watch TV on a large-sized display in the personal computer rather than on a smaller-sized display in the mobile communication terminal.

Further, the mobile communication terminal can store images received from TV in its large-scale memory and the images can be reproduced through an external computer as well as the mobile communication terminal.

Further, since a TV reception module is detachably provided to the mobile communication terminal, it is possible to manufacture the mobile communication terminal with a very compact main body, and also to prevent decrease of reception ratio due to electromagnetic interference between circuits for TV reception and for mobile communications.

While the present invention has been described with reference to exemplary embodiments thereof, it will be understood by those skilled in the art that various changes in form and details may be made therein without departing from the scope of the present invention as defined by the following claims.

1. A mobile communication terminal comprising:
a display unit;
a camera unit for converting an optical signal inputted through a lens system into an electrical signal and outputting the electrical signal;
a TV reception unit for extracting an image signal from a TV signal received over the air; and
a signal processing unit for alternatively processing a first image signal outputted from the camera unit or a second image signal outputted from the TV reception unit, and outputting the processed image signal to the display unit.

2. The mobile communication terminal of claim 1, wherein the signal processing unit controls operations of the camera unit and the TV reception unit using a serial bus.

3. The mobile communication terminal of claim 2, wherein the serial bus is an I²C bus.

4. The mobile communication terminal of claim 2, wherein the signal processing unit comprises:
a media interface for alternatively receiving the first image signal or the second image signal;
an image processor for compressing or processing the image signal received from the media interface;
an image output port for converting the image signal processed in the image processor into display data and outputting the display data;
a bus interface for controlling operations of the camera unit and the TV reception unit; and
a controller for controlling the overall operation of the signal processing unit and an external module.

5. The mobile communication terminal of claim 4, further comprising a flash memory for storing data processed in the signal processing unit, wherein the signal processing unit further comprises a memory controller for controlling the flash memory.

6. The mobile communication terminal of claim 5, wherein the flash memory is a detachable card-type memory.

7. The mobile communication terminal of claim 4, wherein the controller in the signal processing unit controls the bus interface to access a tuner and a decoder in the TV reception unit individually by assigning an address to each of the tuner and the decoder.

8. The mobile communication terminal of claim 1, wherein the TV reception unit is detachably coupled to a main body of the mobile communication terminal.

9. The mobile communication terminal of claim 8, wherein the signal processing unit controls operations of the camera unit and the TV reception unit using a serial bus.

10. The mobile communication terminal of claim 9, wherein the TV reception unit comprises:
a tuner for demodulating a wireless broadcast signal received through an antenna;
a decoder for decoding the demodulated broadcast signal into digital data;
a bus interface for receiving a serial bus control signal from the signal processing unit; and
a TV controller for performing a control operation according to a control signal received from the bus interface.

11. The mobile communication terminal of claim 8, wherein the TV reception unit further comprises an audio processor for processing an audio signal outputted from the tuner, and an audio output unit for outputting the audio signal processed in the audio processor.

12. The mobile communication terminal of claim 1, wherein the signal processing unit further comprises an external device interface for converting the image signal outputted from the TV reception unit into digital image data format and outputting the digital image data format to an external interface port.

13. A mobile communication terminal comprising:
a display unit;
a TV reception unit which is detachably coupled to a main body of the mobile communication terminal and extracts an image signal from a TV signal received over the air; and
a signal processing unit for processing an image signal outputted from the TV reception unit and outputting the processed image signal to the display unit.

14. The mobile communication terminal of claim 13, wherein the signal processing unit controls operation of the TV reception unit using a serial bus.

15. The mobile communication terminal of claim 14, wherein the TV reception unit comprises:
a tuner for demodulating a wireless broadcast signal received through an antenna;
a decoder for decoding the demodulated broadcast signal into digital data;
a bus interface for receiving a serial bus control signal from the signal processing unit; and
a TV controller for performing a control operation according to a control signal received from the bus interface.

16. The mobile communication terminal of claim 14, wherein the TV reception unit further comprises an audio processor for processing an audio signal outputted from the tuner, and an audio output unit for outputting the audio signal processed in the audio processor.
